(19) United States
(12) Patent Application Publication
(10) Pub. No.: US 2015/0327008 A1
(43) Pub. Date: Nov. 12, 2015

(54) Method And Server For Updating Service Information

(71) Applicant: TENCENT TECHNOLOGY (SHENZHEN) COMPANY LIMITED, Shenzhen City (CN)

(72) Inventors: Shuo DENG, Shenzhen (CN); Jiangquan HUANG, Shenzhen (CN); Chuanchuan BO, Shenzhen (CN); Jie HOU, Shenzhen (CN); Liang ZENG, Shenzhen (CN); Chundong HU, Shenzhen (CN); Tianyang LIU, Shenzhen (CN); Ming HE, Shenzhen City (CN); Lei CHEN, Shenzhen City (CN); Fang FANG, Shenzhen (CN)

(21) Appl. No.: 14/739,082

(22) Filed: Jun. 15, 2015

Related U.S. Application Data
(63) Continuation of application No. PCT/CN2013/087554, filed on Nov. 21, 2013.

(30) Foreign Application Priority Data
Dec. 24, 2012 (CN) 201210566340.1

(51) Int. Cl. H04W 4/02; H04W 4/12

(52) U.S. Cl. CPC H04W 4/02; H04W 4/12

(57) ABSTRACT

A method and server updates service information. A service information update request may be received from a mobile terminal device. The service information update request may include a user Identity (ID) of a user. Characteristic information of the user may be determined according to the user ID. Service information may be determined according to the characteristic information of the user and information relating to an area, at which the mobile terminal device may be located. The service information may be sent to the mobile terminal device.

### CROSS-REFERENCE TO RELATED APPLICATIONS

This application is a continuation of International Application No. PCT/CN2013/087554, filed Nov. 21, 2013. This application claims the benefit and priority of Chinese Application No. 201210566340.1, filed Dec. 24, 2012. The entire disclosures of each of the above applications are incorporated herein by reference.

### FIELD

The present disclosure relates to a field of a mobile terminal device and to a method and a server for updating service information.

### BACKGROUND

This section provides background information related to the present disclosure which is not necessarily prior art.

With the development of productive forces and technological advances, human activities are expanding, which generates more and more influence on nature. The weather forecast has become indispensable information in modern society. In daily life, people may arrange holiday activities and dress according to the information provided by the weather forecast. The weather forecast makes a qualitative or quantitative prediction on weather conditions of an area or a place during a period of time according to principles and methods of meteorological data, synoptic meteorology, dynamic meteorology, and statistics. The weather forecast mainly forecasts information, such as whether it is cloudy, sunny, rainy, or snowy, maximum and minimum temperatures, wind direction, and power of an area or a city during a period of time in the future. Observatories may accurately forecast the occurrence location and intensity of natural disasters, such as cold waves, typhoons, and rainstorms, to reduce the loss of industrial and agricultural production and human life.

### SUMMARY

This section provides a general summary of the disclosure, and is not a comprehensive disclosure of its full scope or all of its features.

Various embodiments of the present disclosure provide a method and a server for updating service information, by which different service information may be provided to different users to satisfy requirements of the user and enhance experiences of the user.

Various embodiments of the present disclosure provide a method for updating service information, including:
receiving a service information update request from a mobile terminal device; wherein the service information update request comprises: a user Identity (ID) of a user;
determining characteristic information of the user according to the user ID;
determining service information of the user according to the characteristic information of the user and information relating to an area, at which the mobile terminal device is located; and
sending the service information to the mobile terminal device.

Various embodiments of the present disclosure provide a server, including:
a first receiving unit, to receive a service information update request from a mobile terminal device; wherein the service information update request is comprised of a user Identity (ID) of the user;
a third determination unit, to determine characteristic information of the user according to the user ID;
a fourth determination unit, to determine service information of the user according to the characteristic information of the user and information relating to an area, at which the mobile terminal device is located; and
a first sending unit, to send the service information to the mobile terminal device.

Various embodiments of the present disclosure provide a non-transitory readable storage medium storing a computer program, executed by a computer to perform the above methods.

After the server receives the service information update request from the user, the server may determine the characteristic information of the user according to the user ID in the service information update request, determine the service information of the user according to the characteristic information of the user and the information relating to an area, at which the mobile terminal device is located, and send the service information to the user. This technical scheme may provide the user with corresponding service information according to the characteristic information of the user, satisfy different requirements of the different users, and enhance the experiences of the user.

Further areas of applicability will become apparent from the description provided herein. The description and various embodiments in this summary are intended for purposes of illustration and are not intended to limit the scope of the present disclosure.

### DRAWINGS

The drawings described herein are for illustrative purposes of various embodiments and not all possible implementations, and are not intended to limit the scope of the present disclosure.

FIG. 1 is a flow chart illustrating a method for updating service information according to various embodiments;

FIG. 2 is a flow chart illustrating structure of a server according to various embodiments;

FIG. 3 is a flow chart illustrating a method for updating weather information according to various embodiments;

FIG. 4 is a flow chart illustrating another method for updating weather information according to various embodiments;

FIG. 5 is a diagram illustrating structure of a server according to various embodiments;

FIG. 6 is a diagram illustrating structure of another server according to various embodiments;

FIG. 7 is a diagram illustrating structure of another server according to various embodiments; and

FIG. 8 is a diagram illustrating structure of another server according to various embodiments.

Corresponding reference numerals indicate corresponding parts throughout the several views of the drawings.

### DETAILED DESCRIPTION

Example embodiments will now be described more fully with reference to the accompanying drawings.

Presently, mobile terminal devices may be equipped with weather forecast software. After a mobile terminal device accesses the network, the weather forecast software may regularly obtain weather information from the server or obtain the weather information from the server after receiving a weather information update instruction from a user. In the conventional method, mobile terminal devices in the same area receive the same weather information. The server may not provide different services for different mobile terminal devices, resulting in negative user experiences.

Various embodiments of the present disclosure may provide a method and server for updating weather information. After a server receives a weather information update request from a user, the server may provide current weather information or a weather reminder to the user according to characteristic information of the user, so that the server may send different weather reminders to different users to satisfy requirements of the users and enhance the user experiences.

FIG. 1 is a flow chart illustrating a method for updating service information according to various embodiments of the present disclosure.

Block 101: A service information update request may be received from a mobile terminal device. The service information update request may include a user ID of a user.

Block 102: Characteristic information of the user may be determined according to the user ID.

Block 103: Service information of the user may be determined according to the characteristic information of the user and information relating to an area, at which the mobile terminal device may be located.

Block 104: The server information may be sent to the mobile terminal device.

The service information update request may include a traffic information request. In block 102, a user characteristic table recording a corresponding relationship between the user ID and a traffic characteristic may be searched for according to the user ID to determine a traffic characteristic of the user corresponding to the user ID. For instance, if the traffic information request includes the user ID 123456, the user characteristic table may be searched for with the user ID 123456 to obtain the traffic characteristic of the user corresponding to the user ID 123456. The traffic characteristic of the user may be “a passenger of public transport, least transfer and use the subway less”. The user characteristic table may record a corresponding relationship between the user ID and the traffic characteristic. In the above block 103, traffic plans between the mobile terminal device and a destination may be determined according to the traffic characteristic of the user and a traffic database of the area, at which the mobile terminal device may be located and the best traffic plan may be selected. For instance, if there are traffic plans between the mobile terminal device and the destination determined according to the traffic characteristic of the user and the traffic database of the area, at which the mobile terminal device may be located, the three traffic plans may be ranked according to the “least transfer and use the subway less” in the traffic characteristic of the user and the current state of the traffic jam obtained from the traffic database and the best traffic plan may be determined. In the above block 104, the best traffic plan may be sent to the mobile terminal device.

The service information update request may include a promotion request. In the above block 102, a user characteristic table recording a corresponding relationship between the user ID and a shopping characteristic may be searched for to determine the shopping characteristic of the user corresponding to the user ID. For instance, if the promotion request includes a user ID 234567, the user characteristic table of the user may be searched for with the user ID 234567 to obtain the shopping characteristic of the user corresponding to the user ID 234567. The shopping characteristic of the user may be “living goods and discount sensitive”. The user characteristic table may record the corresponding relationship between the user ID and the shopping characteristic. In the above block 103, promotion of the user may be determined according to the shopping characteristic of the user and promotion of the area, at which the mobile terminal device may be located. For instance, the promotion of the area, at which the mobile terminal device may be located and promotion satisfying the shopping characteristic of the user may be selected from the promotion according to the shopping characteristic of the user. In the above block 104, the promotion of the user may be sent to the mobile terminal device.

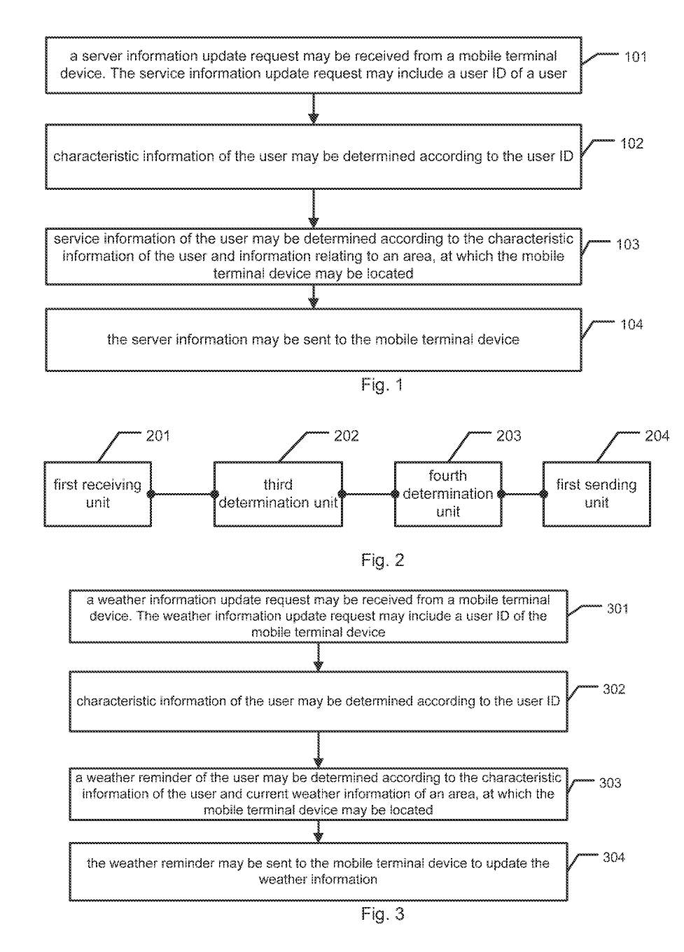

FIG. 2 is a diagram illustrating structure of a server according to various embodiments of the present disclosure.

The server may include a first receiving unit 201, a third determination unit 202, a fourth determination unit 203, and a first sending unit 204. The first receiving unit 201 may receive a server information update request from a mobile terminal device. The service information update request may include a user ID of a user. The third determination unit 202 may determine characteristic information of the user according to the user ID. The fourth determination unit 203 may determine service information of the user according to the characteristic information of the user and the information relating to an area, at which the mobile terminal device may be located. The first sending unit 204 may send the service information to the mobile terminal device.

According to various embodiments of the present disclosure, if the service information update request includes a traffic information request, the third determination unit 202 may further search for a user characteristic table recording a corresponding relationship between the user ID and a traffic characteristic and determine the traffic characteristic of the user corresponding the user ID. The fourth determination unit 203 may further determine traffic plans between the mobile terminal device and a destination according to the traffic characteristic of the user and a traffic database of the area, at which the mobile terminal device may be located and select the best traffic plan from the traffic plans. The first sending unit 204 may further send the best traffic plan to the mobile terminal device.

According to various embodiments of the present disclosure, if the service information update request includes a promotion request, the third determination unit 202 may further search for a user characteristic table recording a corresponding relationship between the user ID and a shopping characteristic and determine the shopping characteristic of the user corresponding to the user ID. The fourth determination unit 203 may further determine promotion information for the user according to the shopping characteristic of the user and promotion of an area, at which the mobile terminal device may be located. The first sending unit 204 may further send the promotion of the user to the mobile terminal device.

According to various embodiments of the present disclosure, the server may be capable of obtaining and storing all kinds of weather information, receiving the weather information from the client terminal device or sending the weather information to the mobile terminal device. In this example, the service information update request may be a weather information update request.

According to various embodiments of the present disclosure, in a process that the weather forecast software may be installed on a mobile terminal device, a unique user ID may be generated. The mobile terminal device may send the user ID, data (i.e., cookies) stored in the mobile terminal in a process of using the mobile terminal device, keywords input by the user in a process of using a searching engine and a flag (i.e., a tag) used by the user in a process of accessing a webpage, etc. to the server. The server may match the data received from the mobile terminal device with that in the database, determine characteristic information of the user corresponding to the user ID, and save a corresponding relationship between the user ID and the characteristic information of the user. The characteristic information of the user may include a career and interests, etc. of the user.

FIG. 3 is a flow chart illustrating a method for updating weather information according to various embodiments of the present disclosure.

Block 301: The weather information update request may be received from a mobile terminal device. The weather information update request may include a user ID of the mobile terminal device.

According to various embodiments of the present disclosure, the mobile terminal device of a user may be equipped with the weather forecast software. After the mobile terminal device accesses a Wireless Fidelity (WIFI) network or a Long Term Evolution (LTE) network, the weather forecast software may automatically send the weather information update request to a server or may send the weather information update request to the server after the user clicks an update button on the display screen of the mobile terminal device.

According to various embodiments of the present disclosure, the server may receive the weather information update request from the mobile terminal device. The weather information update request may include the user ID of the mobile terminal device.

According to various embodiments of the present disclosure, the user ID may be unique. When the weather forecast software is installed, the user ID associated with the mobile terminal device may be generated. The user ID may be used for uniquely identifying the mobile terminal device.

Block 302: Characteristic information of the user may be determined according to the user ID. According to various embodiments, after the server receives the weather information update request from the mobile terminal device, the server may obtain the user ID from the weather information update request and determine the characteristic information according to the user ID. For instance, the characteristic information of the user may be “teacher and climbing”.

Block 303: A weather reminder of the user may be determined according to the characteristic information of the user and current weather information of an area, at which the mobile terminal device may be located. According to various embodiments, after the server determines the characteristic information of the user, the server may further determine the weather reminder of the user according to the characteristic information and the current weather information of the area, at which the mobile terminal device may be located. The current weather information may be wind direction, wind power, temperature, and rainy or sunny, etc.

According to various embodiments of the present disclosure, the weather reminder may be a reminder, a warning or recommended information, etc. corresponding to the characteristic information of the user under a current weather condition. For instance, if the characteristic information of the user is “teacher and climbing” and the current weather information is “weather: sunny; wind direction: southeast; wind power: from grade 3 to 4; temperature: from 15 degree to 20 degree”, the weather reminder of the user may be “The weather is fine and is suitable for climbing”. If the characteristic information of the user is “teacher and climbing” and the current weather information is “weather: rainy; wind direction: northwest; wind power: from grade 6 to 7; temperature: from 5 degree to 10 degree”, the weather reminder of the user may be “The weather is bad and not suitable for climbing, relaxing at home may be a good choice”.

Block 304: Weather reminder may be sent to the mobile terminal device to update the weather information. In this block, the current weather information may be further sent to the mobile terminal device. According to various embodiments of the present disclosure, after the server obtains the weather reminder of the user, the user may send the current weather information and the weather reminder to the mobile terminal device to update the weather information of the user.

According to various embodiments of the present disclosure, after the server receives the weather information update request, the server may determine the characteristic information of the user according to the user ID, determine the weather reminder of the user according to the characteristics information of the user and the current weather information, and send the current weather information and the weather reminder to the mobile terminal device. In this example, the weather reminder of the user may be determined according to the characteristic information of the user, so that different weather services may be provided for different users, requirements of the user may be satisfied, and experiences of the user may be enhanced.

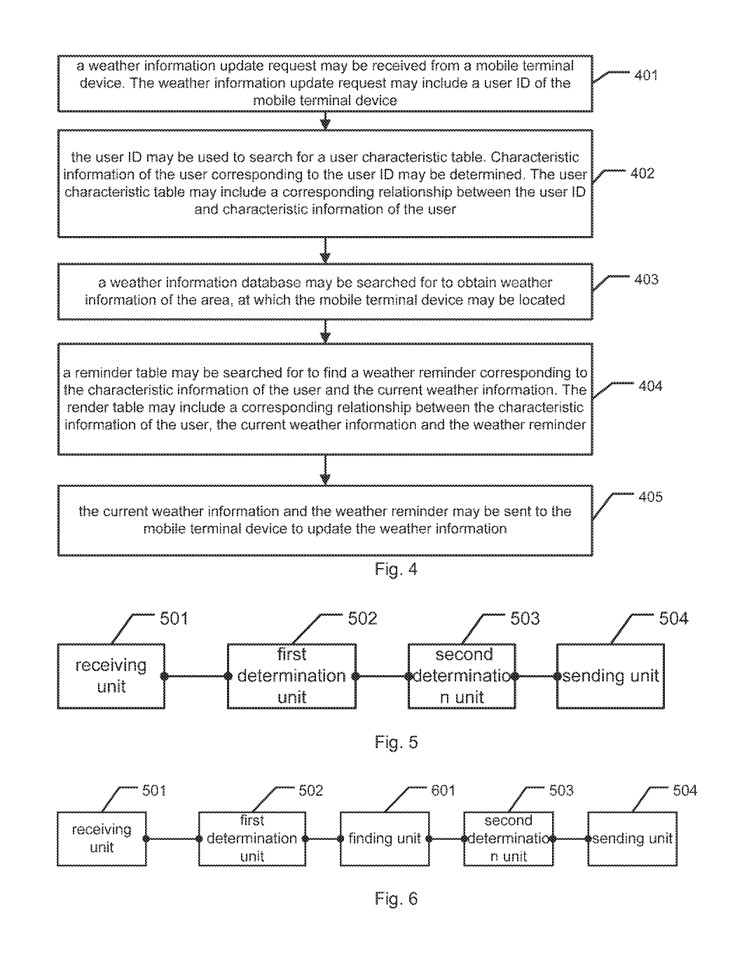

FIG. 4 is a flow chart illustrating another method for updating weather information according to various embodiments of the present disclosure.

Block 401: A weather information update request may be received from a mobile terminal device. The weather information update request may include a user ID of the mobile terminal device.

Block 401 in this example may be similar to that in block 301 in the above example shown in FIG. 1, which may not be repeated here.

Block 402: The user ID may be used to search for a user characteristic table. Characteristic information of the user corresponding to the user ID may be determined. The user characteristic table may include a corresponding relationship between the user ID and characteristic information of the user.

According to various embodiments of the present disclosure, the user characteristic table may be saved in a database of the server. The user characteristic table may include the corresponding relationship between the user ID and the characteristic information of the user. After the server determines the user ID of the mobile terminal device, the server may search for the user characteristic table with the user ID and determine the characteristic information of the user corresponding to the user ID.

Block 403: A weather information database may be searched for to obtain weather information of the area, at which the mobile terminal device may be located. According to various embodiments of the present disclosure, the server may search for the weather information database to determine the weather information of the area, at which the mobile terminal device may be located. The weather information database may store current weather information of different areas. The server may determine the area, at which the mobile terminal may be determined according to an Internet Protocol (IP) address allocated to the mobile terminal device by the server.

Block 404: A reminder table may be searched for to find a weather reminder corresponding to the characteristic information of the user and the current weather information. The render table may include a corresponding relationship between the characteristic information of the user, the current weather information, and the weather reminder.

According to various embodiments of the present disclosure, after the server determines the characteristic information of the user and the weather information, at which the mobile terminal device may be located, the server may search for the reminder table to determine the weather reminder corresponding to the characteristic information of the user and the current weather information. The reminder table may include the corresponding relationship between the characteristic information of the user, the current weather information, and the weather reminder.

It should be noted that the reminder table in this example be preset by an operator and the weather reminders in the reminder table may be preset by the operator. Therefore, the weather reminders in the reminder table may not be limited in this example.

Block 405: The current weather information and the weather reminder may be sent to the mobile terminal device to update the weather information. According to various embodiments of the present disclosure, the server may send the current weather information and the weather reminder to the mobile terminal device to update the weather information.

According to various embodiments of the present disclosure, the server may search for the user characteristic table according to the user ID in the weather information update request to determine the characteristic information of the user, search for the weather information database to determine the current weather information of the area, at which the mobile terminal device sending the weather information update request may be located, search for the reminder table to determine the weather reminder corresponding to the characteristic information of the user and the current weather information, and send the current weather information and the weather reminder to the mobile terminal device to update the weather information. In this example, the weather reminder corresponding to the user may be determined according to the characteristic information of the user, so that different weather reminders may be provided to different users, requirements of the user may be satisfied, and experiences of the user may be enhanced.

According to various embodiments of the present disclosure, a server A may receive a weather information update request from a mobile terminal device B. The weather information update request may include a user ID of the mobile terminal device B. The user ID may be 123456. The server may search for a user characteristic table with the user ID 123456 and obtain characteristic information of the user corresponding to the user ID 123456, i.e. a cyclist and climbing. The server A may further search for a weather information database and determine weather information of an area, i.e. Shenzhen, at which the mobile terminal B may be located. The weather information may be “weather: sunny; wind direction: southeast; wind power: from grade 3 to 4; temperature: from 15 degree to 20 degree”. The server A may search for the reminder table to find the weather reminder “Suitable for outdoor sports, pay attention to prevent sunburn and moisturize” corresponding to the characteristic information of the user “cyclist and climbing” and the current weather information “weather: sunny; wind direction: southeast; wind power: from grade 3 to 4; temperature: from 15 degree to 20 degree”. At last, the server A may send the current weather information “weather: sunny; wind direction: southeast; wind power: from grade 3 to 4; temperature: from 15 degree to 20 degree” and the weather reminder “Suitable for outdoor sports, pay attention to prevent sunburn and moisturize” to the mobile terminal B, so that weather information of the mobile terminal device B may be updated and the mobile terminal device B may obtain the corresponding weather reminder.

FIG. 5 is a diagram illustrating structure of a server in accordance with various embodiments of the present disclosure. The server may include a receiving unit 501, a first determination unit 502, a second determination unit 503, and a sending unit 504.

The receiving unit 501 may receive a weather information update request from a mobile terminal device. The weather information update request may include a user ID of the mobile terminal device. The first determination unit 502 may determine characteristic information of the user according to the user ID after receiving the weather information update request from the receiving unit 501. The second determination unit 503 may determine a weather reminder for the user according to the characteristic information of the user and current weather information of an area, at which the mobile terminal device may be located after the first determination unit 502 determines the characteristic information of the user. The sending unit 504 may send the current weather information and the weather reminder to the mobile terminal device to update the weather information after the second determination unit 503 determines the weather reminder of the user.

According to various embodiments of the present disclosure, after the receiving unit 501 in the server receives the weather information update request from the mobile terminal device, the first determination unit 502 may determine the characteristic information of the user according to the user ID in the weather information update request. The second determination unit 503 may then determine the weather reminder of the user according to the characteristic information of the user and the weather information of the area, at which the mobile terminal device may be located. The sending unit 504 may then send the current weather information and the weather reminder to the mobile terminal device to update the weather information.

According to various embodiments of the present disclosure, after the server receives the weather information update request, the server may determine the characteristic information of the user according to the user ID, determine the weather reminder of the user according to the characteristic information of the user and the current weather information, and send the current weather information and the weather reminder to the mobile terminal device. In this example, the weather reminder of the user may be determined according to the characteristic information of the user, so that different users may be provided with different weather services, requirements of the user may be satisfied, and experiences of the user may be enhanced.

FIG. 6 is a diagram illustrating structure of another server according to various embodiments of the present disclosure.

The server may include the receiving unit 501, the first determination unit 502, the second determination unit 503, and the sending unit 504 as described in the example shown in FIG. 5. The above units may be similar to those described in FIG. 3, which are not repeated here.

In this example, the server may further include a finding unit 601, to search for a weather information database after the first determination unit 502 determines the characteristic information of the user and determine the current weather information of the area, at which the mobile terminal device may be located.

According to various embodiments of the present disclosure, the first determination unit 502 may search for a user characteristic table with the user ID and determine the characteristic information of the user corresponding to the user ID. The user characteristic table may include a corresponding relationship between the user ID and the characteristic information of the user.

According to various embodiments of the present disclosure, the second determine unit 503 may search for a reminder table to find the weather reminder corresponding to the characteristic information of the user and the current weather information. The reminder table may include a corresponding relationship between the characteristic information of the user, the current weather information, and weather reminder.

According to various embodiments of the present disclosure, after the receiving unit 501 in the server receives the weather information update request, the first determination unit 502 may search for the user characteristic table according to the user ID in the received weather information update request and determine the characteristic information of the user corresponding to the user ID. The finding unit 601 may search for the weather information database and obtain the current weather information of the area, at which the mobile terminal device may be located. The second determination unit 503 may search for the reminder table to find the weather reminder corresponding to the characteristic information of the user and the current weather information. At last, the sending unit 504 may send the current weather information and the weather reminder to the mobile terminal device to update the weather information.

According to various embodiments of the present disclosure, the server may search for the user characteristic table according to the user ID in the weather information update request to determine the characteristic information of the user, search for the weather information database to determine the current weather information of the area, at which the mobile terminal device sending the weather information request may be located, search for the reminder table to determine the weather reminder corresponding to the characteristics information of the user and the current weather information, and send the current weather information and the weather reminder to the mobile terminal device to update the weather information. In this example, the weather reminder corresponding to the user may be determined according to the characteristic information of the user, so that different weather reminders may be provided to different users, requirements of the user may be satisfied, and experiences of the user may be enhanced.

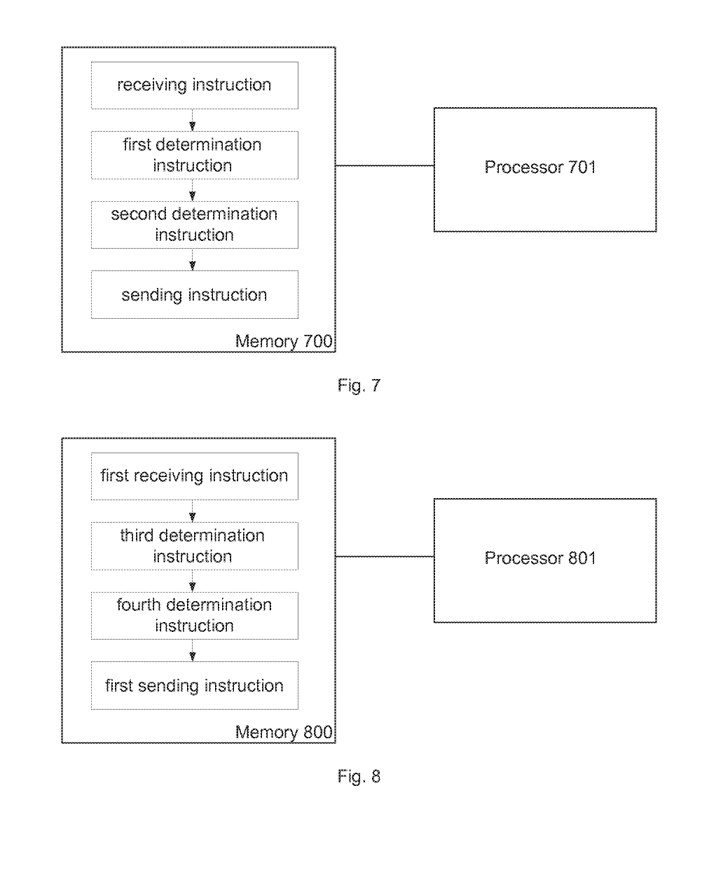

FIG. 7 is a diagram illustrating structure of another server in accordance with various embodiments of the present disclosure.

The server may include a memory 700 and a processor 701. The memory 700 may include a receiving instruction, a first determination instruction, a second determination instruction, and a sending instruction. The processor 701 may communicate with the memory 700 and execute the receiving instruction, the first determination instruction, the second determination instruction, and the sending instruction to respectively execute the operations of the above receiving unit 501, first determination unit 502, second determination unit 503, and sending unit 504. According to various embodiments of the present disclosure, the memory 700 may further include a finding instruction. The processor 701 may further execute the finding instruction to execute the operation of the finding unit 601.

FIG. 8 is a diagram illustrating structure of another server in according to various embodiments of the present disclosure.

The server may include a memory 800 and a processor 801. The memory 800 may include a first receiving instruction, a third determination instruction, a fourth determination instruction, and a first sending instruction. The processor 801 may communicate with the memory 800 and execute the first receiving instruction, the third determination instruction, the fourth determination instruction, and the first sending instruction to respectively execute the operations of the above first receiving unit 201, third determination unit 202, fourth determination unit 203, and the first sending unit 204.

According to various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

What has been described and illustrated herein are various embodiments of the disclosure along with some variations. The terms, descriptions, and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

What is claimed is:

1. A method for updating service information, comprising:
receiving a service information update request from a mobile terminal device; wherein the service information update request comprises: a user Identity (ID) of a user;
determining characteristic information of the user according to the user ID;
determining service information of the user according to the characteristic information of the user and information relating to an area, at which the mobile terminal device is located; and
sending the service information to the mobile terminal device.

2. The method according to claim 1, wherein the service information update request comprises: a traffic information request;
wherein determining the characteristic information of the user according to the user ID comprises:
searching for a user characteristic table recording a corresponding relationship between the user ID and a traffic characteristic according to the user ID; and
determining the traffic characteristic of the user corresponding to the user ID.

3. The method according to claim 2, wherein determining the service information of the user according to the characteristic information of the user and the information relating to the area, at which the mobile terminal device is located comprises:
determining traffic plans between the mobile terminal device and a destination according to the traffic characteristic of the user and a traffic database of the area, at which the mobile terminal device is located and selecting the best traffic plan from the traffic plans;
wherein sending the service information to the mobile terminal device comprises:
sending the best traffic plan to the mobile terminal device.

4. The method according to claim 1, wherein the service information update request comprises: a promotion request;
wherein determining the characteristic information of the user according to the user ID comprises:
searching for a user characteristic table recording a corresponding relationship between the user ID and a shopping characteristic according to the user ID; and
determining the shopping characteristic of the user corresponding to the user ID.

5. The method according to claim 4, wherein determining the service information of the user according to the characteristic information of the user and the information relating to the area, at which the mobile terminal device is located comprises:
determining promotion of the user according to the shopping characteristic of the user and promotion of the area, at which the mobile terminal is located;
wherein sending the service information to the mobile terminal device comprises:
sending the promotion of the user to the mobile terminal device.

6. The method according to claim 1, wherein the service information update request comprises: a weather information update request;
wherein determining service information of the user according to the characteristic information of the user and information relating to an area, at which the mobile terminal device is located comprises: determining a weather reminder of the user according to the characteristic information of the user and weather information of an area, at which the mobile terminal device is located;
wherein sending the service information to the mobile terminal device comprises: sending the weather reminder to the mobile terminal device.

7. The method according to claim 6, further comprising:
sending the weather information to the mobile terminal device.

8. The method according to claim 7, wherein after determining the characteristic information of the user according to the user ID, the method further comprises:
searching for a weather information database; and
obtaining the weather information of the area, at which the mobile terminal device is located.

9. The method according to claim 8, wherein determining the characteristic information of the user according to the user ID comprises:
searching for a user characteristic table with the user ID;
determining the characteristic information of the user corresponding to the user ID; wherein
the user characteristic table comprises: a corresponding relationship between the user ID and the characteristic information of the user.

10. The method according to claim 7, wherein determining the weather reminder of the user according to the characteristic information of the user and the weather information of the area, at which the mobile terminal device is located comprises:
searching for a reminder table;
searching for the weather reminder corresponding to the characteristic information of the user and the weather information; wherein
the reminder table comprises a corresponding relationship between the characteristic information of the user, the weather information and the weather reminder.

11. A server, comprising:
a first receiving unit, to receive a service information update request from a mobile terminal device; wherein the service information update request comprises: a user Identity (ID) of the user;
a third determination unit, to determine characteristic information of the user according to the user ID;
a fourth determination unit, to determine service information of the user according to the characteristic information of the user and information relating to an area, at which the mobile terminal device is located; and
a first sending unit, to send the service information to the mobile terminal device.

12. The server according to claim 11, wherein the service information update request comprises: a traffic information request;
the third determination unit further searches for a user characteristic table recording a corresponding relationship between the user ID and a traffic characteristic according to the user ID and determine the traffic characteristic of the user corresponding to the user ID.

13. The server according to claim 12, wherein
the fourth determination unit further determines traffic plans between the mobile terminal device and a destination according to the traffic characteristic of the user and a traffic database of the area, at which the mobile terminal device is located and select the best traffic plan from the traffic plans; and
the first sending unit further sends the best traffic plan to the mobile terminal device.

14. The server according to claim 11, wherein the service information update request comprises: a promotion request;
the third determination unit further searches for a user characteristic table recording a corresponding relationship between the user ID and a shopping characteristic according to the user ID and determine the shopping characteristic of the user corresponding to the user ID.

15. The server according to claim 14, wherein
the fourth determination unit further determines promotion of the user according to the shopping characteristic of the user and promotion of the area, at which the mobile terminal device is located; and
the first sending unit further sends the promotion of the user to the mobile terminal device.

16. The server according to claim 11, wherein the service information update request comprises: a weather information update request;
wherein the fourth determination unit further determines a weather reminder of the user according to the characteristic information of the user and weather information of an area, at which the mobile terminal device is located; and
the first sending unit further sends the weather reminder to the mobile terminal device.

17. The server according to claim 16,
wherein the first sending unit further sends the weather information to the mobile terminal device.

18. The server according to claim 17, wherein the third determination unit further searches for a user characteristic table with the user ID, determine the characteristic information of the user corresponding to the user ID; wherein the user characteristic table comprises a corresponding relationship between the user ID and the characteristic information of the user.

19. The server according to claim 17, wherein the fourth determination unit further searches for a reminder table, search for the weather reminder corresponding to the characteristic information of the user and the weather information; wherein the reminder table comprises a corresponding relationship between the characteristic information of the user, the weather information and the weather reminder.

20. A non-transitory readable storage medium storing a computer program, executed by a computer to perform blocks in claim 1.
